(19) United States
(12) Patent Application Publication
(10) Pub. No.: US 2014/0119763 A1
(43) Pub. Date: May 1, 2014

(54) IMAGE FORMING APPARATUS

(71) Applicant: Fuji Xerox Co., Ltd., Tokyo (JP)

(72) Inventors: Masaaki YAMAURA, Kanagawa (JP); Masaya NAKATSUHARA, Kanagawa (JP)

(73) Assignee: FUJI XEROX CO., LTD., Tokyo (JP)

(21) Appl. No.: 13/960,927

(22) Filed: Aug. 7, 2013

(30) Foreign Application Priority Data
Oct. 25, 2012 (JP) 2012-235479

(51) Int. Cl. G03G 15/16

(52) U.S. Cl. CPC G03G 21/00
USPC 399/71; 399/101

(57) ABSTRACT

An image forming apparatus includes an image carrying member that carries a toner image; a transfer member whose endless peripheral surface that circulates is disposed so as to oppose the image carrying member; a cleaning member that is disposed so as to contact the peripheral surface of the transfer member and removes toner adhered to a surface of the transfer member; a cleaning bias applying unit that applies a cleaning bias voltage to a portion between the cleaning member and the transfer member; a print mode switching section that switches a print mode between print modes including a borderless print mode and an ordinary print mode; and a bias voltage controller that performs control so that the cleaning bias voltage is a first bias voltage value in the ordinary print mode and a second bias voltage value in the borderless print mode.

### CROSS-REFERENCE TO RELATED APPLICATIONS

This application is based on and claims priority under 35 USC 119 from Japanese Patent Application No. 2012-235479 filed Oct. 25, 2012.

### BACKGROUND

(i) Technical Field

The present invention relates to an image forming apparatus.

(ii) Related Art

In an image forming apparatus that forms a toner image by transferring powdered toner onto a latent image by an electrostatic potential difference, the toner image is formed on an endless peripheral surface of a latent-image carrying member, on which the latent image is formed, by causing the toner to adhere to the endless peripheral surface of the latent-image carrying member. Then, the formed toner image is either directly transferred to a recording medium from the latent-image carrying member or is temporarily first-transferred to an intermediate transfer body from the latent-image carrying member, and is further second-transferred to the recording medium. In general, as a transfer member for transferring a toner image to a recording medium, for example, a transfer belt is used. The transfer belt is provided so as to contact the peripheral surface of the latent-image carrying member or a peripheral surface of the intermediate transfer body. The transfer belt whose endless peripheral surface circulates is tightly stretched on a transfer roller or roller-shaped members. Such a transfer member is used to sandwich the recording medium that has been sent to a transfer region (where the transfer member opposes the latent-image carrying member or the intermediate transfer body), contacts the back surface of the recording medium, and causes the recording medium to pass the transfer region. When a transfer bias voltage is applied, an electric field is formed between the transfer member and the latent-image carrying member or the intermediate transfer body, and the toner image is transferred to the recording medium within the electric field.

In such an image forming apparatus, ordinary printing in which a toner image is transferred with margin areas being left in the outer periphery of a recording medium is generally performed. However, an apparatus that is capable of borderless printing in which a toner image is transferred to the entire surface of a recording medium is being developed. In borderless printing, a toner image is formed in a range that is larger than the size of the recording medium, and the toner image that is formed on the entire surface of the recording medium and that extends to the surrounding of the recording medium is transferred. Therefore, when borderless printing is performed, toner that extends beyond the recording medium is transferred to the peripheral surface of the transfer member at the transfer region.

A slight amount of fog toner adheres to a portion beyond a region of the latent-image carrying member where the toner image is formed. In addition, in an apparatus that directly transfers a toner image from the latent-image carrying member to a recording medium, fog toner is transferred to the peripheral surface of the transfer member from a region at the transfer position where the transfer member does not oppose the recording medium. Further, in an apparatus that temporarily first-transfers a toner image to the intermediate transfer body from the latent-image carrying member and second-transfers the toner image to the recording medium from the intermediate transfer body, fog toner is transferred to the intermediate transfer body at a first transfer position, and fog toner is transferred to the peripheral surface of the transfer member from a region at a second transfer position where the intermediate transfer body does not oppose the recording medium.

When the transfer member circulates with toner adhered to its peripheral surface, the toner adheres to the back surface of the recording medium that has been sent to the transfer region, as a result of which the back surface of the recording medium is stained.

The toner amount that is transferred to the peripheral surface of the transfer member at the transfer region (where the latent-image carrying member or the intermediate transfer body opposes the transfer member) when ordinary printing is performed varies considerably from that when borderless printing is performed. In addition, the toner amount may vary considerably depending upon, for example, temperature or humidity. If it is not possible to sufficiently remove the transferred toner amount that varies considerably from the peripheral surface of the transfer member, the back surface of the recording medium is stained.

### SUMMARY

According to an aspect of the invention, there is provided an image forming apparatus including an image carrying member that carries a toner image; a transfer member whose endless peripheral surface that circulates is disposed so as to oppose the image carrying member, an electric field being formed between the transfer member and the image carrying member, the electric field being used for transferring the toner image to a recording medium that passes a portion between the transfer member and the image carrying member; a cleaning member that is disposed so as to contact the peripheral surface of the transfer member and removes toner adhered to the surface of the transfer member; a cleaning bias applying unit that applies a cleaning bias voltage to a portion between the cleaning member and the transfer member; a print mode switching section that switches a print mode between print modes including a borderless print mode and an ordinary print mode, the toner image being transferred to an entire surface of the recording medium in the borderless print mode, the toner image being transferred to the recording medium having a margin area in the ordinary print mode; and a bias voltage controller that performs control so that the cleaning bias voltage that is applied by the cleaning bias applying unit is a first bias voltage value in the ordinary print mode and is a second bias voltage value in the borderless print mode, the second bias voltage value being set so that a potential difference between the cleaning member and the transfer member is greater than that when the first bias voltage value is applied.

### BRIEF DESCRIPTION OF THE DRAWINGS

An exemplary embodiment of the present invention will be described in detail based on the following figures, wherein:

FIG. 1 is a schematic view of a structure of an image forming apparatus according to an exemplary embodiment of the present invention;

FIG. 2 illustrates the structure of the image forming apparatus shown in FIG. 1 at and near a position where second transfer is performed, and a structure that controls bias voltage that is applied to a portion between a second transfer member and a cleaning member;

FIGS. 3A to 3C each illustrate a state in which, in borderless printing, the back surface of a recording medium is stained by a portion of a toner image extending beyond a recording medium;

FIG. 4 is a graph showing the relationship between the amount of toner remaining on a surface of a second transfer member after cleaning and staining of the back surface of a recording medium by toner;

FIG. 5 illustrates the relationship between cleaning bias voltage that is applied to a portion between the second transfer member and the cleaning member and the amount of toner remaining after cleaning, when the amount of toner on the second transfer member before the cleaning differs; and

FIGS. 6A and 6B each illustrate an example of switching to a bias voltage that is applied to a portion between the second transfer member and the cleaning member.

### DETAILED DESCRIPTION

An exemplary embodiment of the invention of the present application is hereunder described on the basis of the drawings.

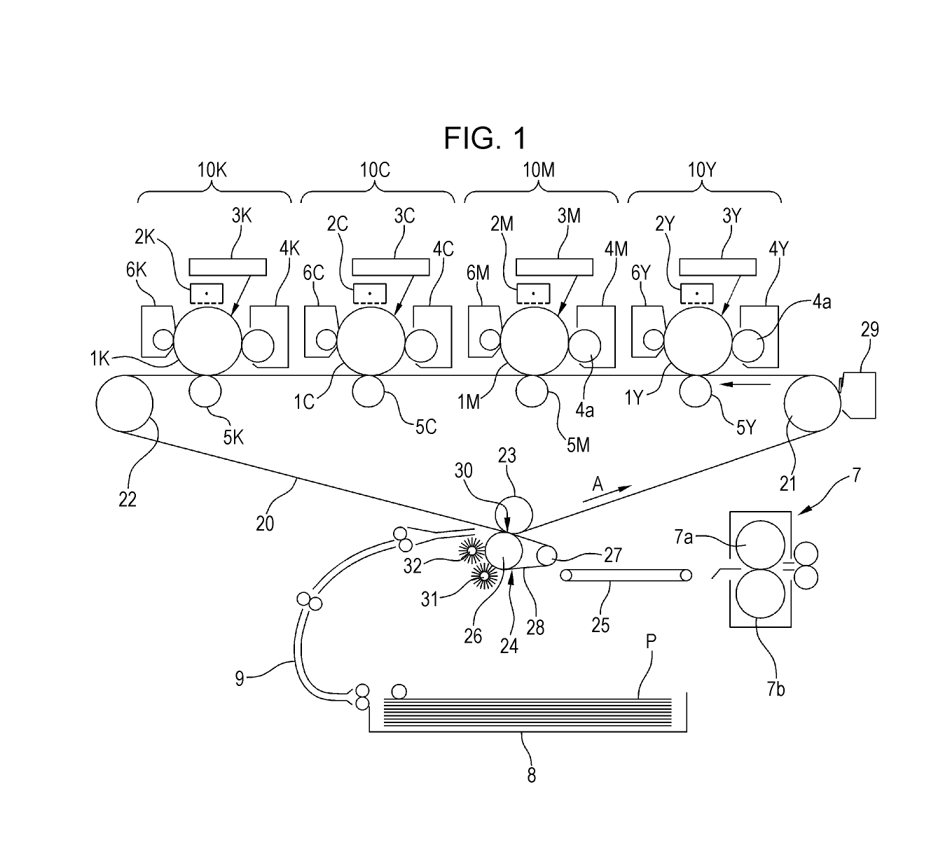

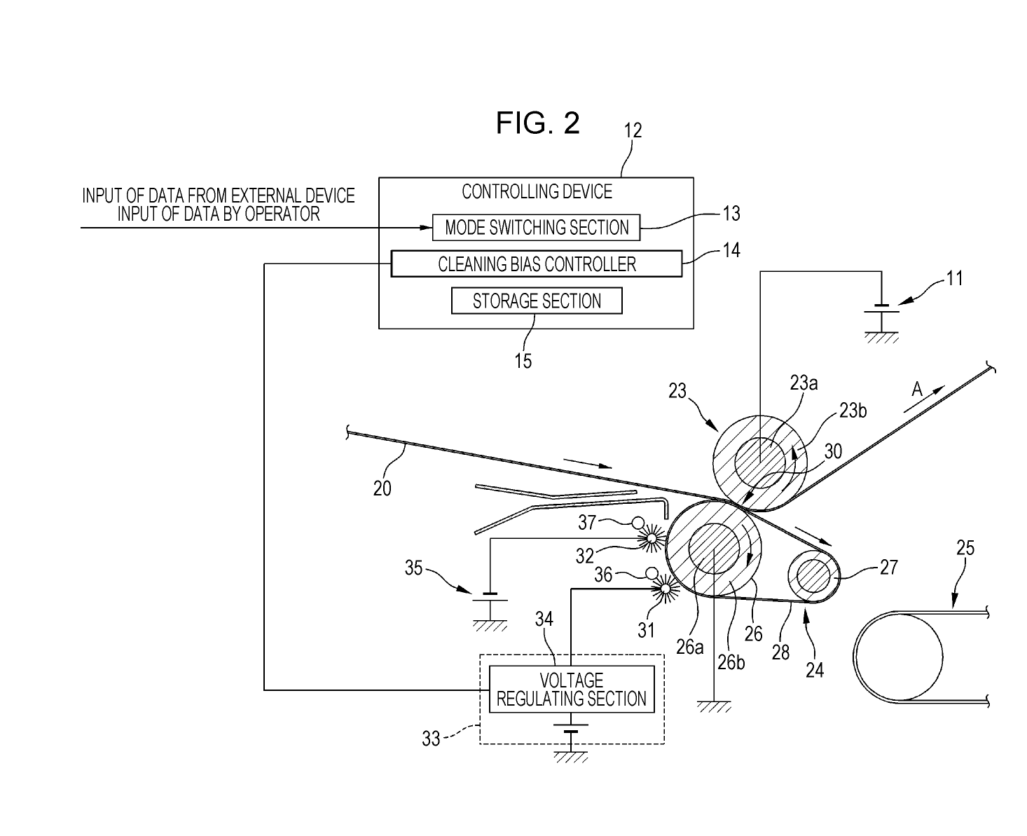

FIG. 1 is a schematic view of a structure of an image forming apparatus according to an exemplary embodiment of the present invention of the present application. FIG. 2 illustrates the structure of the image forming apparatus shown in FIG. 1 at and near a position where second transfer is performed, and a structure that controls bias voltage that is applied to a portion between a second transfer member and a cleaning member.

This image forming apparatus is an image forming apparatus that forms a color image using toners of four colors. The image forming apparatus includes electrophotographic image forming units 10Y, 10M, 10C, and 10K and an intermediate transfer belt 20 that opposes the image forming units 10Y, 10M, 10C, and 10K. The electrophotographic image forming units 10Y, 10M, 10C, and 10K output images of corresponding colors, yellow (Y), magenta (M), cyan (C), and black (K). The intermediate transfer belt 20 functions as an image carrying member, and is stretched tightly so as to oppose the image forming units 10. A peripheral surface of the intermediate transfer belt 20 is subjected to circulation driving. In a direction in which the intermediate transfer belt 20 circulates, a second transfer member 24 for performing a second-transfer operation is disposed downstream of the positions of the intermediate transfer belt 20 where the image forming units 10 oppose the intermediate transfer belt 20. The second transfer member 24 opposes the intermediate transfer belt 20. The second transfer member 24 functions as a transfer member. A recording medium P that is in the form of a sheet is sent to a second transfer position 30 (where the second transfer member 24 opposes the intermediate transfer belt 20) from a sheet container 8 via a transport path 9, and a toner image on the intermediate transfer belt 20 is transferred to the recording medium. A transport device 25 and a fixing device 7 are provided downstream of the second transfer position 30 in the transport path of the recording medium. The transport device 25 transports the recording medium to which the toner image has been transferred. The fixing device 7 fixes the toner image to the recording medium by heating and pressing the toner image. A discharged sheet holding section (not shown) that holds stacked recording media to which toner images have been fixed is provided further downstream of the second transfer position 30.

A cleaning device 29 for the intermediate transfer belt is provided downstream of the second transfer position 30 in the direction of circulation of the intermediate transfer belt 20. The cleaning device 29 collects toner remaining on the intermediate transfer belt 20 after the second transfer. In order to collect toner that has been transferred from the intermediate transfer belt 20 to the second transfer member 24 at the second transfer position 30, a first cleaning member 31 and a second cleaning member 32 for the second transfer member are disposed at locations opposing an endless peripheral surface of the second transfer member 24.

The image forming apparatus is provided with print modes including an ordinary print mode M1 and a borderless print mode M2. In the ordinary print mode M1, a toner image is formed with margin areas being left at the outer periphery of a recording medium. In the borderless print mode M2, a toner image is formed on the entire surface of a recording medium. Switching between these print modes is performed by a controlling device 12 on the basis of data that is input from an external device or data that is input from, for example, an operation panel by an operator.

The image forming units 10 are such that the image forming unit 10Y that forms a yellow toner image, the image forming unit 10M that forms a magenta toner image, the image forming unit 10C that forms a cyan toner image, and the image forming image 10K that forms a black toner image are disposed in that order from an upstream side of the intermediate transfer belt 20 in the circulation direction thereof. Each image forming unit 10 includes a photoconductor drum 1 on whose surface an electrostatic latent image is formed, a charging device 2 that charges the surface of its associated photoconductor drum 1, a developing device 4 that forms a toner image by selectively transferring toner to the latent image formed on its associated photoconductor drum, a first transfer roller 5 that first-transfers the toner image on its associated photoconductor drum 1 to the intermediate transfer belt 20, and a photoconductor cleaning device 6 that removes toner remaining on its associated photoconductor drum after the transfer. In each image forming unit 10, the charging device 2, the developing device 4, the first transfer roller 5, and the cleaning device 6 are disposed around the photoconductor drum 1. An exposure device 3 that generates image light on the basis of an image signal is provided at each photoconductor drum 1. An upstream side of each photoconductor drum 1 opposing its associated developing device 4 is irradiated with the image light by its associated exposure device 3, so that an electrostatic latent image is formed on each photoconductor drum 1.

Each photoconductor drum 1 includes an organic photoconductor layer that is placed on a circular cylindrical member formed of a metal, with its metallic portion being electrically connected to ground. Each photoconductor drum 1 may be one in which bias voltage is applied thereto.

Each charging device 2 includes an electrode wire that is stretched tightly with an interval being provided between the electrode wire and the peripheral surface of its associated photoconductor drum 1 serving as a member to be charged. By applying a voltage to a portion between each electrode wire and its associated photoconductor drum 1, corona discharge is generated, to charge the surface of each photoconductor drum 1.

Although, in the exemplary embodiment, charging devices that charge the photoconductor drums by corona discharge are used as described above, solid-state dischargers, or, for example, roller-shaped or blade-shaped contact charging devices or roller-shaped or blade-shaped non-contact charging devices may also be used.

Each exposure device 3 generates a flashing laser light beam on the basis of an image signal, and uses the laser light to scan its associated rotating photoconductor drum 1 in a main scanning direction (axial direction) thereof using a polygon mirror. This causes an electrostatic latent image corresponding to an image of its corresponding color to be formed on the surface of each photoconductor drum 1.

Each developing device 4 uses a two-component developer containing toner and magnetic carriers. Each developing device 4 includes a developing roller 4a at a position opposing its associated photoconductor drum 1. A two-component developer layer is formed on the peripheral surface of each developing roller 4a that rotates. Toner is transferred from the peripheral surface of each developing roller 4a to its associated photoconductor drum 1 to make visible each electrostatic latent image. Toners that have been consumed in forming the images are replenished in accordance with the amounts of consumption.

In the exemplary embodiment, each photoconductor drum 1 is charged so as to have a negative polarity by its associated charging device 2, and negatively charged toner is transferred to a portion whose charging potential has been attenuated by the exposure.

The first transfer rollers 5 are disposed at an inner side of the intermediate transfer belt 20 at positions opposing the photoconductor drum 1Y of the image forming unit 10Y, the photoconductor drum 1M of the image forming unit 10M, the photoconductor drum 1C of the image forming unit 10C, and the photoconductor drum 1K of the image forming unit 10K. First transfer bias voltages are applied to a portion between the first transfer roller 5Y and the photoconductor drum 1Y, a portion between the first transfer roller 5M and the photoconductor drum 1M, a portion between the first transfer roller 5C and the photoconductor drum 1C, and a portion between the first transfer roller 5K and the photoconductor drum 1K. This causes toner images on the associated photoconductor drums to be electrostatically transferred to portions of the intermediate transfer belt 20 that pass first transfer positions opposed by the first transfer rollers 5.

The photoconductor cleaning devices 6 remove toners remaining on the photoconductor drums 1 after the transfer by cleaning blades that contact the peripheral surfaces of the associated photoconductor drums 1.

The intermediate transfer belt 20 is an endless film member including layers that are placed upon each other. In addition, the intermediate transfer belt 20 functions as an image carrying member. Further, the intermediate transfer belt 20 is stretched tightly upon a driving roller 21 that is rotationally driven, an adjusting roller 22 that adjusts the tilting of the intermediate transfer belt 20 in a widthwise direction thereof, and an opposing roller 23 that is supported at a position that opposes the second transfer member 24, and circulates in the direction of arrow A shown in FIG. 1.

The second transfer member 24 that is disposed so as to oppose the opposing roller 23 with the intermediate transfer belt 20 being nipped between the opposing roller 23 and the second transfer member 24 includes a second transfer roller 26, an auxiliary roller 27, and a second transfer belt 28 that is tightly stretched upon the second transfer roller 26 and the auxiliary roller 27. The second transfer belt 28 is nipped between the opposing roller 23 and the second transfer roller 26 while the second transfer belt 28 is placed upon the intermediate transfer belt 20, and circulates as the intermediate transfer belt 20 is subjected to circulation driving. When a recording medium is transported into a portion between the intermediate transfer belt 20 and the second transfer belt 28, the recording medium is nipped and transported.

The second transfer roller 26 includes a metallic core 26a and a rubber outer peripheral layer 26b to which conductive particles are added and that is formed around the outer peripheral surface of the core 26a. The opposing roller 23 includes a metallic core 23a and an outer peripheral layer 23b that is formed around the outer peripheral surface of the core 23a. One or more outer peripheral layers 23b may be provided.

As shown in FIG. 2, a second-transfer bias voltage is applied from a transfer-bias power supply device 11 to a portion between the second transfer roller 26 and the opposing roller 23, so that a transfer electric field is formed at the second transfer position 30.

The fixing device 7 heats and presses a recording medium to which a toner image has been transferred at the second transfer position 30, to fix the toner image to the recording medium. The fixing device 7 includes a heating roller 7a and a pressing roller 7b. A heating source is built in the heating roller 7a. The pressing roller 7b press-contacts the heating roller 7a. The recording medium to which the toner image has been transferred is transported to a portion where the heating roller 7a and the pressing roller 7b contact each other, and is heated and pressed at the portion between the heating roller 7a and the pressing roller 7b that are rotationally driven, so that the toner image is fixed to the recording medium.

The cleaning device 29 for the intermediate transfer belt removes from the peripheral surface of the intermediate transfer belt 20 toner that remains after the transfer of the toner image to the recording medium at the second transfer position 30. The cleaning device 29 includes a cleaning blade that contacts the peripheral surface of the intermediate transfer belt 20. The cleaning blade removes the toner adhered to the peripheral surface of the intermediate transfer belt 20 by scraping it off.

The first cleaning member 31 and the second cleaning member 32 are disposed so as to contact the peripheral surface of the second transfer belt 28. The cleaning members 31 and 32 each include a metallic rotary shaft and brush hairs that are radially attached around the rotary shaft. The brush hairs are formed of a resin material in which particles are mixed for imparting conductivity to the brush hairs. A voltage is applied to the brush hairs from each rotary shaft, so that an electric field is formed at a portion between the brush hairs and the second transfer roller 26. That is, a cleaning bias voltage is applied from a first cleaning bias power supply 33 to a portion between the electrically grounded second transfer roller 26 and the first cleaning member 31 (that contacts an upstream side of the second transfer belt 28 in a circulation direction thereof), to apply a potential having a positive polarity to the first cleaning member 31. A cleaning bias voltage is applied from a second cleaning bias power supply 35 to a portion between the second transfer roller 26 and the second cleaning member 32 (that contacts a downstream side of the second transfer belt 28), so that the polarity of the potential of the second cleaning member 32 becomes a negative polarity. Therefore, the first cleaning member 31 to which a bias voltage having a positive polarity is applied primarily removes toner charged to have a negative polarity from the peripheral surface of the second transfer belt 28, whereas, the second cleaning member 32 to which a voltage having a negative polarity is applied primarily removes toner charged to have a positive polarity.

Reference numerals 36 and 37 in FIG. 2 denote brushing-off members that contact the brush hairs of the first cleaning member 31 and the second cleaning member 32, respectively, to brush off any toner adhered to the peripheral surface of the second transfer belt 28 from the peripheral surface of the second transfer belt 28.

The first cleaning member 31 functions as a cleaning member. The first cleaning bias power supply 33 that applies a cleaning bias voltage to the first cleaning member 31 functions as a cleaning bias applying unit. The voltage that is applied to the first cleaning member from the first cleaning bias power supply 33 is controlled by the controlling device 12.

The controlling device 12 includes, in addition to a mode switching section 13, a cleaning bias controller 14. The mode switching section 13 is provided for switching to a print mode selected from the print modes of the image forming apparatus. The cleaning bias controller 14 controls the cleaning bias voltage that is applied to the first cleaning member 31. The controlling device 12 has the function of controlling image formation operations that are performed on recording media by the image forming apparatus.

The mode switching section 13 functions as a print mode switching section. On the basis of information that is input from an external device or information that is input by an operator using, for example, an operation panel, the mode switching section 13 selects one print mode from the print modes including, for example, the ordinary print mode M1 and the borderless print mode M2, and switches control so as to form an image in accordance with the selected print mode.

The cleaning bias controller 14 functions as a bias voltage controller. On the basis of the switching to the print mode performed by the mode switching section 13, the cleaning bias controller 14 controls the value of a voltage that is applied to the first cleaning member 31 from the first cleaning bias power supply 33. That is, the cleaning bias controller 14 operates a voltage regulating section 34 of the first cleaning bias power supply 33 so that a first bias voltage value V1 is applied when the print mode is switched to the ordinary print mode M1, and so that a second bias voltage value V2 is applied when the print mode is switched to the borderless print mode M2.

The first bias voltage value V1 and the second bias voltage value V2 are previously set and stored in a storage section 15. The second bias voltage value V2 that is applied when the borderless print mode M2 is executed is set so that a potential difference between the second transfer roller 26 and the first cleaning member 31 is greater than the first bias voltage value V1 that is applied when the ordinary print mode M1 is executed.

Although, in the exemplary embodiment, the first bias voltage value V1 and the second bias voltage value V2 are certain values that are previously set, the bias voltage values may be controlled on the basis of, for example, environmental conditions, such as temperature or humidity, and other conditions, in addition to the print mode to be executed. However, if, for example, the environmental condition is the same, the second bias voltage value V2 that is applied when the borderless print mode M2 is executed is controlled so that the potential difference is greater than the first bias voltage value V1 that is applied when the ordinary print mode M1 is executed.

Such an image forming apparatus operates as follows. Electrostatic latent images are formed on the four photoconductor drums 1, respectively, and toners are transferred from the developing devices 4 to form toner images. The toner images are transferred to the positions of the intermediate transfer belt 20 that oppose the first transfer rollers 5 and are placed upon each other on the intermediate transfer belt 20, to form a color toner image. This toner image is transported to the second transfer position 30 by the circulation of the intermediate transfer belt 20, and is transferred to a recording medium P from the intermediate transfer belt 20.

When such an image formation operation is executed in the ordinary print mode M1, the toner image is formed in a region that is smaller than the size of the recording medium, and is transferred at the second transfer position 30 so that margin areas are left in an outer peripheral portion of the recording medium. A slight amount of fog toner often adheres to a portion of the intermediate transfer belt 20 that is beyond a range that carries the toner image, such as a non-image region that is formed between a region that carries the image and a region that carries the next image. Toner that adheres to a region that does not oppose the recording medium at the second transfer position 30 is transferred to the second transfer belt 28 at the second transfer position 30. The second transfer belt 28 circulates and passes a position where it opposes the first cleaning member 31 to which the first bias voltage value V1 is applied and a position where it opposes the second cleaning member 32, so that a portion of the toner is removed by the cleaning members 31 and 32. A portion of the toner is not removed by the cleaning members 31 and 32, and remains on the second transfer belt 28. However, the amount of toner adhered to the non-image region is small, as a result of which the back surface of the recording medium is not immediately stained.

In contrast, when an image is to be formed in the borderless print mode M2, toner images are formed in a range that is larger than the size of the recording medium. When the toner images are transferred to the recording medium at the second transfer position 30, portions of the toner images extend outward beyond outer peripheral edges of the recording medium, as a result of which the portions of the toner extending outwards beyond the outer peripheral edges of the recording medium are transferred to the second transfer belt 28. At this time, the amount of toner adhered to the second transfer belt 28 is considerably greater than the amount of fog toner that exists in the ordinary print mode. In addition, as when the ordinary print mode M1 is executed, fog toner adheres to the second transfer belt 28 from the non-image region. The second transfer belt 28 circulates and passes the position where the second transfer belt 28 opposes the first cleaning member 31 and the position where the second transfer belt 28 opposes the second cleaning member 32, so that a portion of the toner is removed. At this time, the second voltage value V2 that is set so that the potential difference between the first cleaning member 31 and the second transfer roller 26 is greater than the first bias voltage V1 is applied to the first cleaning member 31, and the first cleaning member 31 has a positive polarity. Therefore, a large amount of negatively charged toner adhered to the second transfer belt 28 is primarily removed by the first cleaning member 31.

When the borderless print mode M2 is executed, toner that extends beyond the outer peripheral edges of the recording medium passing the second transfer position 30 and that adheres to the second transfer belt 28 may adhere to and stain the back surface of the recording medium if the toner is not removed by one cleaning operation.

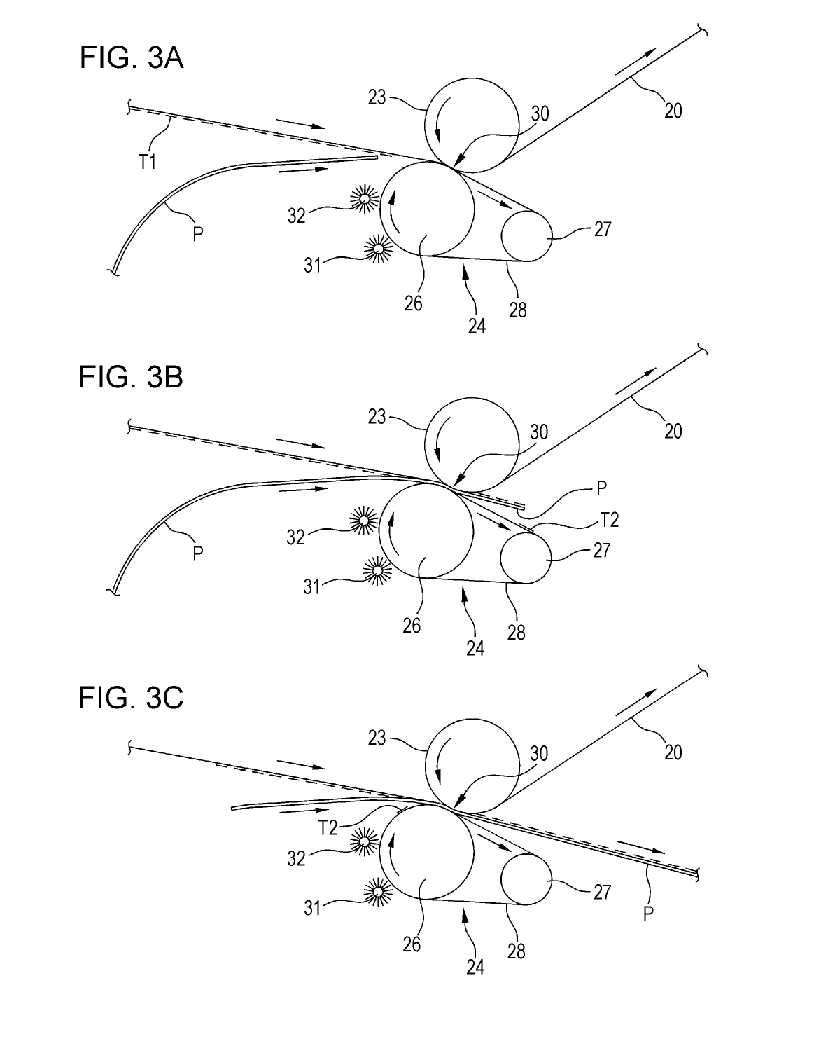

When, as shown in FIG. 3A, the borderless print mode M2 is executed, at the second transfer position 30 (where a recording medium P is nipped to transfer a toner image), a toner image T1 that is carried by the intermediate transfer belt P is larger than the size of the recording medium P and a front edge of the toner image 1 extends forwardly beyond a leading edge of the recording medium P. When this portion passes the second transfer position 30, as shown in FIG. 3B, this portion is transferred to the second transfer belt 28. Then, as the second transfer belt 28 circulates, this portion passes the position where the second transfer belt 28 and the first cleaning member 31 oppose each other and the position where the second transfer belt 28 and the second cleaning member 32 oppose each other. If any toner that cannot be completely removed by the cleaning members 31 and 32 remains, residual toner T2 reaches the second transfer position 30 again. If the peripheral length of the second transfer belt 28 is shorter than the length of the recording medium P in a transport direction thereof, as shown in FIG. 3C, the back portion of the recording medium P in the transport direction thereof is still at the second transfer position 30 when the residual toner T2 has reached the second transfer position 30. Therefore, the residual toner T2 adheres to the back surface of the recording medium P.

Therefore, in the borderless print mode M2, the toner T2 extending beyond the leading edge of the recording medium P and adhered to the second transfer belt 28 is to be removed so that staining on the back surface of the recording medium P is an allowable degree by one passage of the toner T2 past the positions where the second transfer belt 28 opposes the first cleaning member 31 and the second cleaning member 32.

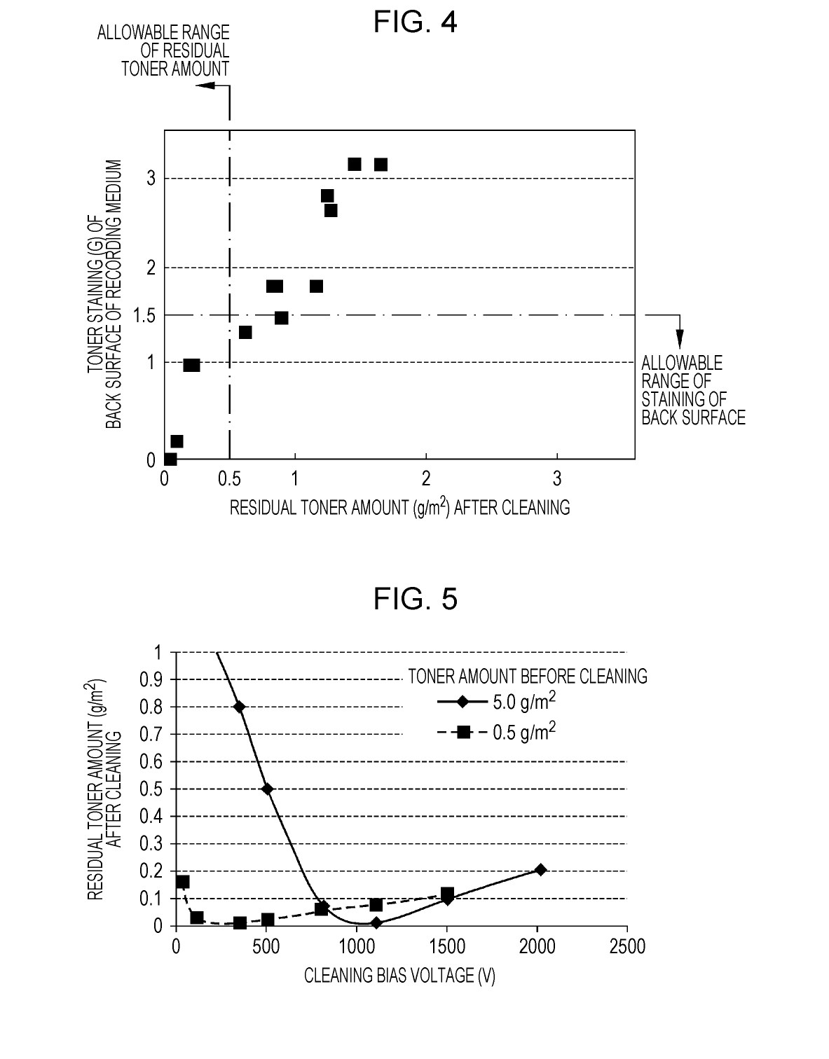

FIG. 4 illustrates the relationship between the toner amount remaining on the second transfer member 28 after cleaning and staining of the back surface of the recording medium by toner.

The staining of the back surface by the toner in FIG. 4 is visually confirmed, and an allowable range thereof is up to 1.5G (grade). As shown in FIG. 4, in order to keep the staining of the back surface by toner to not more than 1.5G, the toner amount remaining on the second transfer belt 28 after cleaning is set to 1 g/m² or less, and, desirably, 0.5 g/m² or less.

Cleaning bias voltages that are applied to the first cleaning member 31 and the second cleaning member 32 are set so that, as mentioned above, the toner amount remaining on the second transfer belt 28 after cleaning is within an allowable range of staining of the back surface of the recording medium by the toner. The cleaning bias voltage that is applied to a portion between the first cleaning member 31 and the second transfer roller 26 is switched to the first bias voltage value V1 or the second bias voltage V2 due to the following reasons.

FIG. 5 illustrates the relationship between cleaning bias voltage that is applied to the first cleaning member 31 and the toner amount remaining on the second transfer belt 28 due to incomplete removal by the first cleaning roller. The relationship is obtained by tests that are performed while changing the toner amount that is carried by the second transfer belt 28 before cleaning.

As shown in FIG. 5, the toner amount remaining on the second transfer belt 28 is reduced and cleaning efficiency is increased as the cleaning bias voltage value is increased. However, when the bias voltage value is further increased, the residual toner amount is increased. This may be because an electric discharge is generated due to an increase in the bias voltage value, as a result of which an electric field is not generated, thereby reducing the cleaning efficiency. Therefore, it is desirable that the cleaning bias voltage value is set within a range in which cleaning efficiency is good.

When the toner amount carried by the second transfer belt 28 is varied, the bias voltage range at which the cleaning efficiency becomes good varies considerably. This may be because, if the toner amount carried by the second transfer belt 28 is increased, the resistance value between the surface of the second transfer belt 28 and the first cleaning member 31 is increased, as a result of which the cleaning bias voltage value causing electric discharge is greater than that when the toner amount carried by the second transfer belt 28 is small.

Accordingly, since the bias voltage value at which cleaning efficiency is good varies, it is desirable that, when the toner amount adhered to the second transfer belt 28 is large, the cleaning bias voltage value that is applied to the portion between the first cleaning member 31 and the second transfer roller 26 be set so as to be greater than the potential difference between the first cleaning member 31 and the second transfer roller 26; and, when the toner amount adhered to the second transfer belt 28 is small, the cleaning bias voltage value that is applied to the portion between the first cleaning member 31 and the second transfer roller 26 be set so as to be less than the potential difference between the first cleaning member 31 and the second transfer roller 26. That is, the bias voltage value that is applied to the portion between the first cleaning member 31 and the second transfer roller 26 is controlled on the basis of the toner amount on the second transfer belt 28, so that good cleaning efficiency is maintained even if the toner amount on the second transfer belt varies.

Therefore, in the ordinary print mode M1 in which the amount of toner adhered to the second transfer belt 28 is less that that when forming an image in the borderless print mode M2, the first bias voltage value V1 that is less than the second bias voltage value V2 is applied to the portion between the first cleaning member 31 and the second transfer roller 26, and the second bias voltage value V2 that is greater than the first bias voltage value V1 is applied when the borderless print mode M2 is executed. This makes it possible to perform cleaning operations in accordance with the ordinary print mode M1 and the borderless print mode M2, respectively.

In the exemplary embodiment, the first bias voltage value V1 that is applied to the portion between the first cleaning member 31 and the second transfer roller 26 is set from approximately 100 V to 700 V, and the second bias voltage value V2 that is applied to the portion between the first cleaning member 31 and the second transfer roller 26 is set from approximately 800 V to 1300 V.

The bias voltage values are examples, and may be changed according to, for example, the material of which the second transfer member 24 is formed or the material of which the first cleaning member 31 is formed.

Next, control that is performed when image formation operations are continuously performed on multiple sheets in the borderless print mode M2 is described.

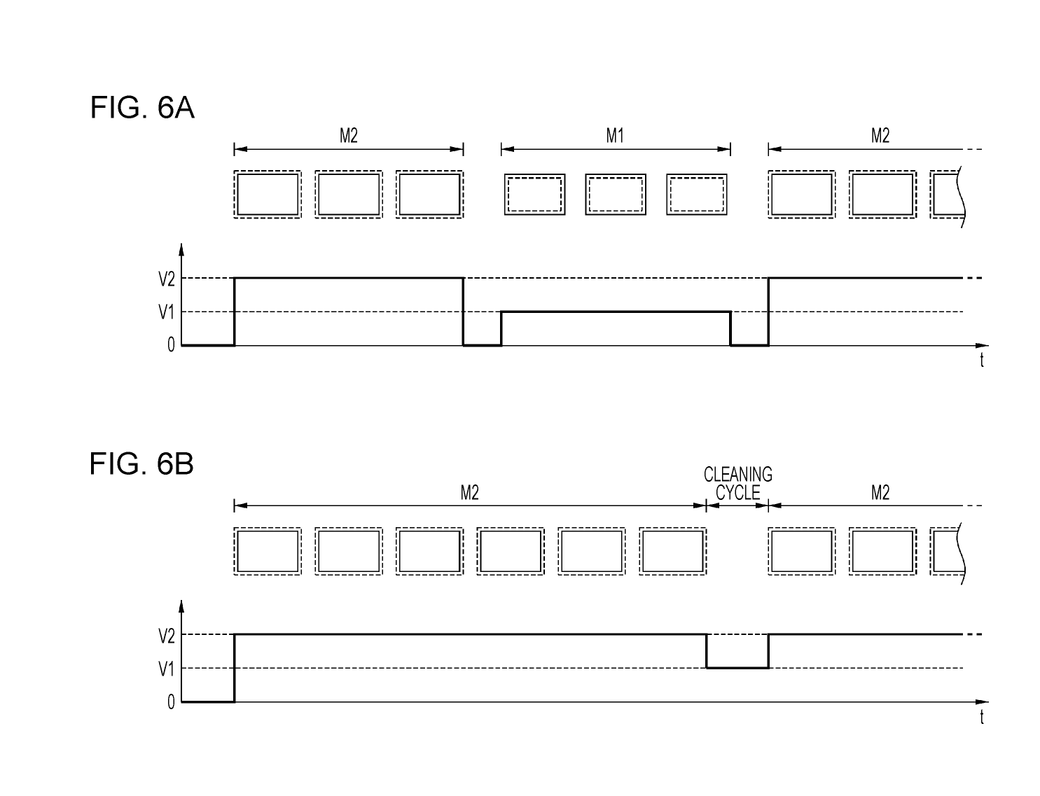

As shown in FIG. 6A, when an image formation operation is performed in the ordinary print mode M1, the first bias voltage value V1 is applied to a portion between the first cleaning member 31 and the second transfer roller 26. When switching is performed from the ordinary print mode M1 to the borderless print mode M2 by the mode switching section 13, the second bias voltage value V2 is applied to the portion between the first cleaning member 31 and the second transfer roller 26. When image formation operations are continuously performed on the number of sheets that is greater than or equal to that set under preset conditions in the borderless print mode M2, the applications of cleaning bias voltage and the image formation operations are controlled as shown in FIG. 6B.

When the image formation operations are performed in the borderless print mode M2, the second bias voltage value V2 is applied to the portion between the first cleaning member 31 and the second transfer roller 26. When, in this state, images are formed on the number of sheets that is set under the preset conditions, latent-image formation operations and toner-image formation operations on the photoconductor drums 1 are temporarily stopped. At this time, the circulation driving of the intermediate transfer belt 20 and the second transfer belt 28 are continued, and the first bias voltage value V1 when forming an image in the ordinary print mode M1 is applied to the portion between the first cleaning member 31 and the second transfer roller 26. The second transfer belt 28 is subjected to circulation driving, and the circulation driving of the second transfer belt 28 is continued until the entire peripheral surface of the second transfer belt 28 passes the position where it opposes the first cleaning member 31 at least once. This causes the peripheral surface of the second transfer belt 28 to be cleaned by the first cleaning member 31 while the first bias voltage V1 is applied thereto, so that the toner on the second transfer belt 28 is removed. Thereafter, an image formation operation in the borderless print mode M2 is started again, and the second bias voltage value V2 is applied again to the portion between the first cleaning member 31 and the second transfer roller 26. Further, when image formation operations in the borderless print mode M2 are continuously performed, the above-described operations are repeated, and a cleaning cycle in which the second transfer belt 28 is cleaned after stopping an image formation operation and image transfer is performed each time borderless images are formed on the set number of sheets.

When image formation operations are continuously performed in the borderless print mode M2, the cleaning bias voltage that is applied to the portion between the first cleaning member 31 and the second transfer roller 26 and the image formation operations are controlled as described above, so that staining of the back surface of a recording medium is suppressed as described below.

When the image formation operations in the borderless print mode M2 are performed, a cleaning bias voltage value that allows efficient cleaning in terms of the amount of toner that extends beyond the recording medium and that is transferred to the second transfer belt 28, that is, the second bias voltage value V2 is applied to the portion between the first cleaning member 31 and the second transfer roller 26. Therefore, the toner of a toner image extending beyond the outer peripheral edges of the recording medium and that is transferred to the second transfer belt 28 is efficiently removed by the first cleaning member 31, so that staining of the back surface of a back portion of the recording medium is prevented from occurring.

However, fog toner adhered to the intermediate transfer belt 20 at the non-image region between successively formed toner images is transferred to the second transfer belt 28 and, in a state in which the second bias voltage value V2 is applied, the toner may not be sufficiently removed from the second transfer belt 28. That is, as shown in FIG. 5, the second bias voltage value V2 may not allow toner, such as fog toner, of an amount that is considerably smaller than the amount of toner that extends beyond the recording medium to be sufficiently removed from the second transfer belt because the cleaning bias voltage value for the considerably smaller amount of toner falls outside the range of proper cleaning bias voltage values.

The amount of fog toner is considerably smaller than the amount of toner of the toner image that extends beyond the outer peripheral edges of the recording medium and that is transferred. The amount of residual toner after passing the position where the first cleaning member 31 and the second transfer roller 26 oppose each other is not an amount that causes immediate staining of the back surface of the recording medium. However, when image formation operations are repeated, and second transfer is performed while the second bias voltage value V2 is applied to the portion between the first cleaning member 31 and the second transfer roller 26, fog toner accumulates on the second transfer belt 28. The accumulated toner may stain the back surface of the recording medium. Each time image formation operations are performed on the preset number of sheets in the borderless print mode M2, the second transfer belt 28 is cleaned by applying the first bias voltage value V1 to the portion between the first cleaning member 31 and the second transfer roller 26. The first bias voltage value V1 is set so that the potential difference between the first cleaning member 31 and the second transfer roller 26 is less than the second bias voltage value V2, and allows effective removal of the amount of fog toner that is less than the amount of toner that extends from the recording medium and that is transferred.

Therefore, when the borderless print mode M2 is continuously executed, staining of the back surface of a recording medium by fog toner and staining of the back surface of the recording medium occurring when a toner image that extends beyond the outer peripheral edges of the recording medium is transferred to the second transfer belt 28 are both effectively suppressed.

The “preset conditions” under which cleaning of the second transfer member is performed after continuously forming borderless images in the exemplary embodiment of the present invention may be a preset number of sheets or may be the number of sheets that is set so as to vary on the basis of environmental conditions, such as temperature or humidity. That is, when the number of sheets on which borderless images are continuously formed becomes the preset number of sheets, it is possible to temporarily stop forming borderless images and perform the cleaning cycle. Instead of previously setting the number of sheets, it is possible to, for example, detect the amount of toner adhered to the second transfer belt 28 after the second transfer belt 28 has passed the positions where the second transfer belt 28 opposes the cleaning members 31 and 32 and start the cleaning cycle when the detected value becomes greater than or equal to a preset value. Alternatively, the timing at which an image formation operation is started again by switching to the second bias voltage value again after switching from the second bias voltage value V2 to the first bias voltage value V1 may be set on the basis of, for example, the number of circulations of the second transfer belt 28, or a preset time (seconds), or a detected value of toner amount obtained by detecting the amount of toner on the second transfer belt.

The image forming apparatus is not limited to the exemplary embodiment described above. Therefore, other exemplary embodiments are possible within the scope of the present invention.

In the exemplary embodiment, toner images on the photoconductor drums 1 are first-transferred to the intermediate transfer belt 20, the toner images of the corresponding colors that are placed upon each other on the intermediate transfer belt 20 are second-transferred to a recording medium at the second transfer position 30, and the intermediate transfer belt 20 functions as an image carrying member. However, for example, toner images may be transferred directly to a recording medium from the photoconductor drums, and the photoconductor drums may function as image carrying members.

Although, in the exemplary embodiment, the cleaning bias voltage is applied to a portion between the first cleaning member 31 and the second transfer roller 26, it is possible to provide the second transfer belt 28 to include an electrode layer and apply the cleaning bias voltage to a portion between the electrode layer and the first cleaning member 31.

Further, although, in the above-described exemplary embodiment, the second transfer member includes a second transfer roller, an auxiliary roller, and a second transfer belt, the second transfer member may include roller-like members, or may have other structures.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image carrying member that carries a toner image;
a transfer member whose endless peripheral surface that circulates is disposed so as to oppose the image carrying member, an electric field being formed between the transfer member and the image carrying member, the electric field being used for transferring the toner image to a recording medium that passes a portion between the transfer member and the image carrying member;
a cleaning member that is disposed so as to contact the peripheral surface of the transfer member and removes toner adhered to the surface of the transfer member;
a cleaning bias applying unit that applies a cleaning bias voltage to a portion between the cleaning member and the transfer member;
a print mode switching section that switches a print mode between a plurality of print modes including a borderless print mode and an ordinary print mode, the toner image being transferred to an entire surface of the recording medium in the borderless print mode, the toner image being transferred to the recording medium having a margin area in the ordinary print mode; and
a bias voltage controller that performs control so that the cleaning bias voltage that is applied by the cleaning bias applying unit is a first bias voltage value in the ordinary print mode and is a second bias voltage value in the borderless print mode, the second bias voltage value being set so that a potential difference between the cleaning member and the transfer member is greater than that when the first bias voltage value is applied.

2. The image forming apparatus according to claim 1, wherein the image forming apparatus is set so that, when image formation operations are to be continuously performed in the borderless print mode, after borderless images are formed on a plurality of recording media until a predetermined condition is reached, the second bias voltage value that is applied to the portion between the cleaning member and the transfer member is switched to the first bias voltage value, and, with the first bias voltage value being applied, the transfer member is rotated, after which the first bias voltage value is switched to the second bias voltage value to restart an image formation operation in the borderless print mode.

3. The image forming apparatus according to claim 2, wherein the predetermined condition is reached when the number of recording media on which borderless images are continuously formed becomes a preset number of the recording media.

4. The image forming apparatus according to claim 2, wherein the predetermined condition is reached when an amount of toner adhered to the transfer member becomes greater than or equal to a preset value.
